(19) United States
(12) Patent Application Publication
(10) Pub. No.: US 2026/0371124 A1
(43) Pub. Date: Nov. 19, 2026

(54) TERMINAL DEVICE, BASE STATION DEVICE, CONTROL METHOD, AND COMPUTER-READABLE STORAGE MEDIUM FOR BEAM SELECTION FOR WIRELESS COMMUNICATION USING ARTIFICIAL INTELLIGENCE (AI)/MACHINE LEARNING (ML)

(71) Applicant: KDDI CORPORATION, Tokyo (JP)

(72) Inventors: Taishi WATANABE, Fujimino-shi (JP); Takeo OHSEKI, Fujimino-shi (JP); Issei KANNO, Fujimino-shi (JP)

(21) Appl. No.: 19/753,023

(22) Filed: Jul. 24, 2026

Related U.S. Application Data
(63) Continuation of application No. PCT/JP2025/001547, filed on Jan. 20, 2025.

(30) Foreign Application Priority Data
Feb. 1, 2024 (JP) 2024-014260

(51) Int. Cl. H04W 24/08

(52) U.S. Cl. CPC H04W 24/08

(57) ABSTRACT

A terminal device measures reference signals transmitted using second beams, respectively, from a base station device, the base station device being capable of forming a plurality of first beams, and a beam to be used for communication with the terminal device being determined for the base state device from among the plurality of first beams by at least some of measurement results obtained by measurement of the reference signals being input to a trained model obtained through machine learning, a total number of the second beams being fewer than the first beams, determines a configuration of a report of the measurement results of the reference signals, and transmits a notification relating to the configuration of the report to the base station device and transmits a measurement report of the reference signals to the base station device based on the configuration.

### CROSS-REFERENCE TO RELATED APPLICATIONS

This application is a continuation of International Patent Application No. PCT/JP2025/001547 filed on Jan. 20, 2025, which claims priority to and the benefit of Japanese Patent Application No. 2024-014260 filed on Feb. 1, 2024, the entire disclosures of which are incorporated herein by reference.

### BACKGROUND OF THE INVENTION

### Field of the Invention

The present invention relates to a beam selection technology for wireless communication using artificial intelligence (AI)/machine learning (ML).

### Description of the Related Art

In the standardization of the 3rd Generation Partnership Project (3GPP), the use of artificial intelligence (AI)/machine learning (ML) in a communication device capable of forming multiple beams for wireless communication is being studied to determine which of the multiple beams is to be used for communication with a partner device. NPL 1 describes an AI/ML model in which a terminal device measures reference signal received power (RSRP) for some beams included in a plurality of beams with narrow beam widths that can be formed in a network (base station device), and a beam to be used for communication is selected from all of the plurality of beams based on the measured RSRP.

### CITATION LIST

### Non-patent literature

[NPL 1] 3GPP (registered trademark) document R1-2203142

Methods for selecting a beam using an AI/ML model require sufficient RSRP feedback from a terminal device. However, if the feedback from a terminal device is performed excessively, unnecessary overhead increases, and this may lower the throughput, for example.

### SUMMARY OF THE INVENTION

The present invention provides a technology for appropriately configuring feedback from a terminal device to a base station device for a method for selecting a beam to be used by the base station device with use of an AI/ML model.

A terminal device according to one aspect of the present invention comprises: a measurement unit configured to measure reference signals transmitted using second beams, respectively, from a base station device, the base station device being capable of forming a plurality of first beams, and a beam to be used for communication with the terminal device being determined for the base state device from among the plurality of first beams by at least some of measurement results obtained by measurement of the reference signals by the terminal device being input to a trained model obtained through machine learning, a total number of the second beams being fewer than the first beams; a determination unit configured to determine a configuration of a report of the measurement results of the reference signals; and a transmission unit configured to transmit a notification relating to the configuration of the report to the base station device and transmit a measurement report of the reference signals to the base station device based on the configuration of the report.

A base station device according to one aspect of the present invention comprises: a transmission unit configured to transmit reference signals by using second beams, respectively, a total number of the second beams being fewer than a plurality of first beams formable by the base station device; a reception unit configured to receive, from a terminal device that received the reference signals, a notification relating to a configuration of a report of measurement results of the reference signals, and receiving a measurement report of the reference signals based on the configuration of the report; and a determination unit configured to determine a beam to be used for communication with the terminal device from among the plurality of first beams by inputting at least some of the measurement results of the reference signals included in the measurement report to a trained model obtained through machine learning.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1A is a diagram showing a configuration example of a wireless communication system.

FIG. 1B is a diagram showing a configuration example of the wireless communication system.

FIG. 2A is a diagram showing an example of machine learning for beam determination.

FIG. 2B is a diagram showing the example of machine learning for beam determination.

FIG. 3A is a diagram showing another example of machine learning for beam determination.

FIG. 3B is a diagram showing the other example of machine learning for beam determination

FIG. 4 is a diagram showing an example of a hardware configuration of a base station device and a terminal device.

FIG. 5 is a diagram showing an example of a functional configuration of the terminal device.

FIG. 6 is a diagram showing an example of a functional configuration of the base station device.

FIG. 7 is a diagram showing an example of a flow of processing executed in the wireless communication system.

FIG. 8 is a diagram showing an example of a flow of processing executed in the wireless communication system.

FIG. 9A is a diagram showing a flow of processing for giving notification of condition information.

FIG. 9B is a diagram showing a flow of processing for giving notification of condition information.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Configuration

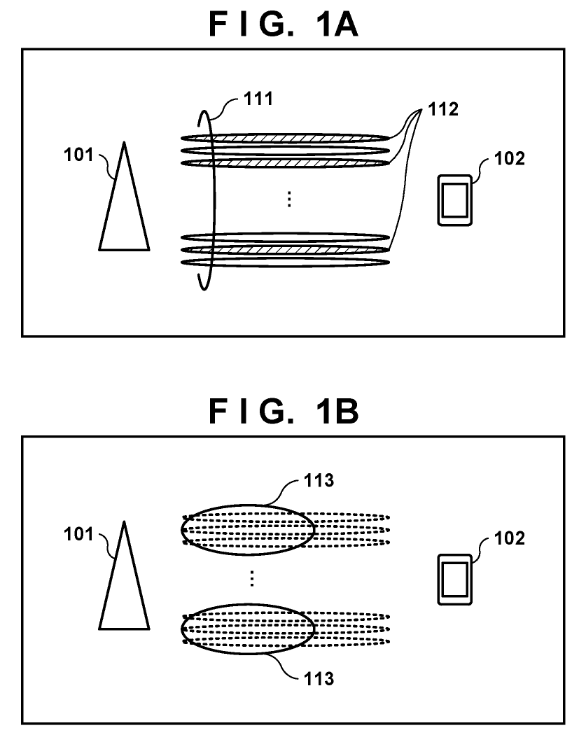

FIGS. 1A and 1B show configuration examples of a wireless communication system according to the present embodiment. This wireless communication system is, for example, a cellular communication system conforming to the cellular communication standard of the 3rd Generation Partnership Project (3GPP (registered trademark)) and includes a base station device 101 and a terminal device 102. The base station device 101 can form a large number of first beams 111 and communicates with the terminal device 102 by selectively using any of the beams. The beam used is selected based on results of measurement performed by the terminal device 102 on the reception quality of reference signals transmitted using all of the beams, for example. This selection is particularly effective in a downlink through which signals are transmitted from the base station device 101 to the terminal device 102. Examples of the reference signals referred to here include a synchronization signal/physical broadcast channel (SS/PBCH) block (SSB) and a channel state information reference signal (CSI-RS). Examples of the reception quality include reference signal received power (RSRP), reference signal received quality (RSRQ), signal-to-interference plus noise ratio (SINR), and the like. For example, the terminal device 102 measures the reception quality of reference signals transmitted using the large number of first beams 111, respectively, and notifies the base station device 101 of the measurement results. Based on the measurement results, the base station device 101 determines, for example, a beam having high reception quality as the beam to be used for communication with the terminal device 102.

However, in the case where the terminal device 102 measures reference signals for all of the first beams 111 to identify the reception quality and notifies the base station device 101 of the reception quality, a large number of measurements need to be performed, and accordingly, the beam determination takes a long time. Moreover, a large number of notifications regarding the large number of beams may waste radio resources. In contrast, for example, if some beams for which good quality is expected to be obtained at the terminal device 102 are selected and the terminal device 102 is caused to carry out the measurement and report on only the selected beams, the measurement can be simplified and the amount of reported information can be reduced. However, in this processing, the beam to be used cannot be selected from all of the first beams 111. In this regard, studies are being made on the use of artificial intelligence (AI)/machine learning (ML) for the selection of the beam to be used. For example, at least some of measurement results obtained by the terminal device 102 by measuring reference signals transmitted using second beams that are fewer than the first beams 111 are input to a trained model obtained through machine learning. Then, a small number of candidates of the beam to be used by the base station device 101 for communication (e.g., downlink communication and, in some cases, uplink communication) with the terminal device 102 may be output from the trained model. Thereafter, the reception quality of reference signals may be measured by the terminal device 102 with respect to the small number of candidates, and the beam to be used for communication may be determined based on the measurement results. Alternatively, rather than the candidates, the beam to be used for communication may be determined at once based on the output of the trained model.

It should be noted that the second beams for which the reception quality of reference signals is input to the trained model may be some of the first beams 111, like beams 112 shown in FIG. 1A, for example. That is to say, some beams 112 (e.g., each set for every predetermined number of first beams 111) of the large number of first beams 111 that can be formed by the base station device 101 are set as the second beams, and the terminal device 102 measures the reception quality of reference signals transmitted using the second beams. Then, at least some of the measurement results are input to the trained model to determine the beam to be used by the base station device 101 for communication with the terminal device 102. Alternatively, as the second beams, it is also possible to use, for example, beams having a wider beam width than the first beams 111, like beams 113 shown in FIG. 1B. For example, in a case where SSBs are transmitted using the beams 113 and CSI-RSs are transmitted using the first beams 111, the terminal device 102 transmits measurement results of the SSBs to the base station device 101, and the beam to be used by the base station device 101 for communication with the terminal device 102 is determined from among the first beams 111 by inputting the measurement results to the trained model.

As described above, beam selection based on artificial intelligence/machine learning makes it possible to determine a beam suitable for communication between the base station device 101 and the terminal device 102 from all of the first beams 111 without the terminal device 102 measuring and reporting the radio quality of all of the first beams 111. It should be noted that the beam selection based on artificial intelligence/machine learning can be executed in the base station device 101, but may be executed in another network node, for example. In this case, the base station device 101 provides information received from the terminal device 102 to the network node, and can acquire information of a beam determined based on the provided information from the network node. As described above, the beam selection does not necessarily have to be performed by the base station device 101.

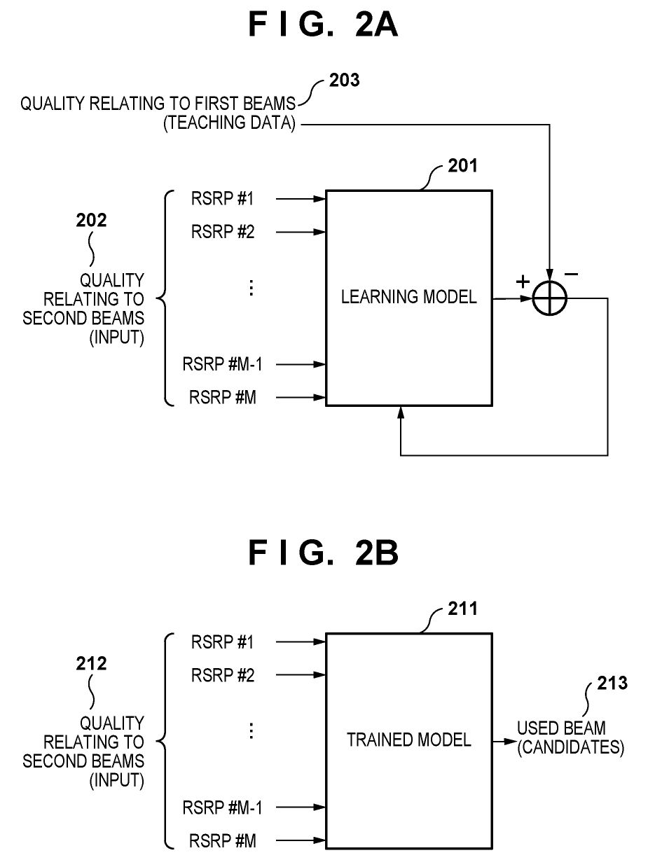

An example of machine learning for the beam determination will be described with reference to FIGS. 2A and 2B. FIG. 2A shows an example of a learning phase in the machine learning, and FIG. 2B shows an example after the learning phase has been completed and a trained model for processing for the beam determination has been obtained. These are merely examples, and other configurations may be used to determine a beam to be used.

In the learning phase of the example shown in FIG. 2A, machine learning is performed with the terminal device 102 by using information regarding the reception quality of reference signals transmitted using the first beams 111, respectively, as teaching data 203, and information regarding the reception quality of reference signals transmitted using the second beams, respectively, as an input 202. Here, the teaching data may be data of the reception quality itself corresponding to each of the first beams 111, or data identifying a beam to be selected when the reception quality is obtained, for example. Although FIG. 2A shows RSRP as the reception quality of the second beams, the reception quality may be any other index value such as RSRQ, SINR, signal-to-noise ratio (SNR), or the like. The reception quality of the second beams is input to a learning model 201, and information in a form corresponding to the teaching data 203 is output based on the input information. A difference value between the output and the teaching data 203 is then fed back to the learning model 201 to update the learning model 201. When this processing is repeatedly executed and a state where the difference value is sufficiently small is maintained, or when the number of times of the repetition of the processing has reached a predetermined number, the machine learning is finished, and the learning model at that time is output as a trained model.

In FIG. 2B, the trained model 211 is supplied with an input 212 regarding the reception quality of the same second beams as those used as the input 202 in the learning phase. The trained model 211 infers and outputs a beam 213 (or candidates of the beam in some cases) to be used by the base station device 101 for communication with the terminal device 102 based on the input 212. In this manner, the beam to be used for communication with the terminal device 102 may be determined from all of the first beams 111, based on measurement results of reference signals transmitted using beams fewer than the first beams 111.

As for the input 202/212 of the reception quality regarding the second beams, for example, values not higher than a predetermined level may be input as the predetermined level. For example, when the predetermined level is set to -60 dBm for RSRP, all information of the reception quality not higher than -60 dBm may be input as -60 dBm to the learning model 201/trained model 211. That is to say, all values of the reception quality that are low and accordingly envisaged to have little influence on the learning and inference may be handled as being the same quality. In the example shown in FIGS. 2A and 2B, beams corresponding to the respective input reception quality values out of the second beams are distinguished based on input ports. For example, RSRP regarding a beam corresponding to RSRP#1 is always input to a port labeled RSRP#1, and RSRPs of other beams are not input to this port. This is because, if this order is not fixed, the learning will not end, or the precision of inference will decrease.

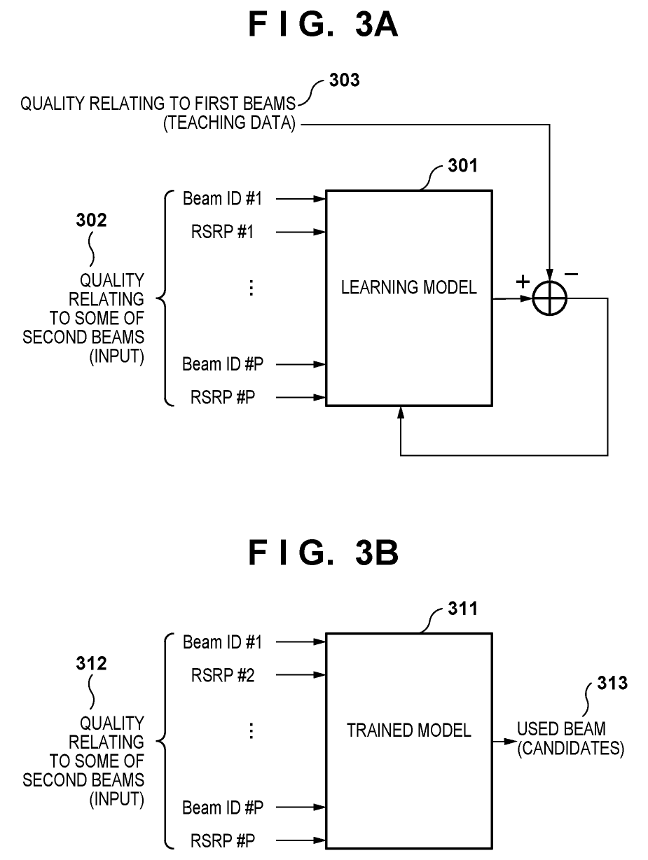

FIGS. 3A and 3B show another example of machine learning for the beam determination. In the example shown in FIGS. 3A and 3B, measurement results regarding only some of the second beams are input to a learning model 301 and a trained model 311. For example, even when a large number of measurement results such as measurement results of all the second beams are obtained from the terminal device 102, only some of the measurement results are used as an input 302 to the learning model 301 to perform machine learning. Teaching data 303 is the same as that in FIG. 2A. Likewise, only some of measurement results of the second beams may be used as an input 312 to the trained model 311. It should be noted that the number of measurement results included in the input 302 is the same as the number of measurement results included in the input 312. That is to say, when, for example, eight measurement result values are input as the input 302 in the learning phase, eight measurement result values are input as the input 312 in the inference phase as well. It should be noted that, if only the measurement result values are used as the input 302 and the input 312, it may become unclear for which beams of the second beams the measurement result values were obtained, and this may result in a decrease in the learning efficiency and inference performance. Therefore, the input 302 and the input 312 may include information indicating beams for which the measurement result values were obtained. That is to say, beam IDs of the second beams and the reception quality (RSRP in the example shown in FIGS. 3A and 3B) of reference signals corresponding to the beam IDs may be used as the input 302 and the input 312.

By using artificial intelligence (AI)/machine learning (ML) as described above, a beam to be used for communication can be selected based on observation results of reference signals transmitted using a relatively small number of beams, giving consideration to all the beams available for the base station device 101. However, a case can be envisaged in which, after a measurement report regarding reference signals is fed back from the terminal device 102 to the base station device 101 as described above, part of the measurement report is not used as an input for the trained model. Feedback of such information that is not used wastes radio resources and hinders improvement in the frequency utilization efficiency of the system as a whole. Also, even if more precise beam selection can be realized based on a more detailed report, advantages of such highly precise selection cannot be obtained if the particle size (quantization level) in reporting the reception quality of reference signals is fixedly set. Therefore, this embodiment provides a technology for appropriately configuring feedback when a beam to be used by the base station device 101 is determined using artificial intelligence (AI)/machine learning (ML).

For example, the terminal device 102 is allowed to autonomously determine the configuration of a report. That is to say, the terminal device 102 measures reference signals (e.g., CSI-RS or SSB) transmitted using a plurality of second beams, respectively, which are fewer than the large number of first beams 111 described above, and determines how to report the measurement results of the second beams. For example, the terminal device 102 may determine measurement results to be reported out of the measurement results of the second beams, and determine to notify the base station device 101 of only the measurement results determined to be reported. Then, the terminal device 102 determines the number of report target beams such that those measurement results will be reported. That is to say, in the case of a conventional measurement report (CSI-Report) relating to CSI-RS, the maximum number of report target beams may be designated by the base station device 101, whereas in this embodiment, the terminal device 102 is allowed to determine the number of report target beams. In one example, based on measurement results of the reception quality of the reference signals transmitted using the second beams, respectively, the terminal device 102 may determine not to include, in the report target beams, beams whose reception quality values are lower than a predetermined value. Also, if the terminal device 102 recognizes the number of reception quality values to be input to the trained model, the terminal device 102 may determine the number of reception quality values to be reported such that reception quality values of beams not more than the number will be reported.

Also, the terminal device 102 may determine the number of signals (messages) to be used to transmit the measurement results. For example, in the case of a conventional CSI Report, one report may include measurement results of up to four beams, and when the number of report target beams is 4n-3 to 4n, n signals may be used to report measurement results of the report target beams. In one example, in accordance with this method, when the determined number of report target beams is 4n-3 to 4n, the terminal device 102 may determine to use n signals for the report transmission. However, there is no limitation to this configuration, and the terminal device 102 may determine to use, for example, two or more signals for the report transmission regarding four beams. In this case, the terminal device 102 may further determine the number of measurement results to be included in each report. For example, when it is necessary to increase the amount of information to be reported with respect to each beam, the terminal device 102 may reduce the number of reception quality values (the number of beams) included in one report.

Furthermore, the terminal device 102 may determine the content of a report regarding each beam, for example. For example, the terminal device 102 may determine whether or not to express the reception quality of a reference signal with use of a difference value based on the reception quality regarding one specific beam. In the case where such a difference value is used, if a difference between a first value indicating a reference measurement result and a second value indicating a measurement result is large, for example, it is envisaged that the specific value of the difference cannot be indicated. That is to say, when the difference is not larger than a predetermined value, the specific value of the difference can be indicated, but when the difference is larger than the predetermined value, there is a possibility that a report will be made as if the difference is the predetermined value, and the specific value of the difference will not be reported. Therefore, for example, if the difference between the first value indicating the reference measurement result and the second value indicating a measurement result is not larger than the predetermined value, the terminal device 102 may determine to use the difference value in the report, and if the difference is larger than the predetermined value, the terminal device 102 may determine not to use the difference value in the report. Furthermore, the terminal device 102 may vary a bit width used to indicate the reception quality. For example, if the base station device 101 is to be notified of more detailed information, the terminal device 102 may increase the bit width, and if it is sufficient to give rough information to the base station device 101, the terminal device 102 may reduce the bit width.

It should be noted that, if the terminal device 102 independently determines the configuration of a report and transmits a measurement report in accordance with the configuration to the base station device 101, the base station device 101 cannot obtain measurement result information normally because the base station device 101 does not recognize the configuration. Therefore, in the present embodiment, the terminal device 102 transmits a notification relating to the determined configuration of a report to the base station device 101. This enables the base station device 101 to recognize the configuration of the report, and normally obtain information of measurement results of reference signals from the measurement report using the configuration determined by the terminal device 102.

The terminal device 102 may notify the base station device 101 of information relating to the configuration of a measurement report with use of a signal separate from the measurement report, or may notify the base station device 101 of the information with use of the same signal as the measurement report. In one example, in the notification relating to the configuration of a report, the terminal device 102 may request the base station device 101 to use the configuration of the report. In this case, the base station device 101 identifies the configuration of the measurement report based on the request, and transmits an instruction according to the identified content to the terminal device 102. For example, the base station device 101 may select approval, rejection, or modification in response to the request, and transmit a response including the selection result to the terminal device 102. For example, when approving all the requested configuration, the base station device 101 may transmit a response indicating approval to the terminal device 102, and when the requested configuration is acceptable if it is partially modified, the base station device 101 may transmit a response indicating the content to be modified to the terminal device 102. Also, when rejecting the use of the requested configuration, the base station device 101 transmits a response indicating rejection to the terminal device 102. According to this configuration, for example, a report configured to be suitable for the selection of a beam using the trained model can be transmitted from the terminal device 102 to the base station device 101. It should be noted that the terminal device 102 may notify the base station device 101 of information indicating the configuration of a measurement report, and the base station device 101 may unconditionally accept the configuration. For example, in the case where information relating to the configuration of a measurement report and the measurement report are transmitted using one signal including the information and the measurement report, the base station device 101 may unconditionally accept the configuration and analyze the measurement report.

Also, the base station device 101 may determine some configuration elements of a report in advance and notify the terminal device 102 of the determined configuration elements. Then, the terminal device 102 may independently determine elements of the report other than those designated by the base station device 101, generate a measurement report composed of the determined elements and the elements that the terminal device is notified of by the base station device 101, and transmit the measurement report to the base station device 101. In one example, the base station device 101 may notify the terminal device 102 of a configuration element relating to the number of beams for which measurement results of corresponding reference signals are to be reported out of the second beams. In this case, the terminal device 102 transmits a measurement report regarding reference signals transmitted using the designated number of beams to the base station device 101, and independently determines at least one of the number of signals to be used to transmit the measurement report, the content of the report regarding each report target beam, and the bit width of information indicating measurement results of the reference signals, and transmits the measurement report having the determined configuration to the base station device 101. It should be noted that the base station device 101 may notify the terminal device 102 of, for example, information designating at least one of the number of signals to be used to transmit the measurement report, the content of the report regarding each report target beam, and the bit width of information indicating measurement results of the reference signals, rather than the number of beams for which measurement results are to be reported. The terminal device 102 may determine the configuration of a measurement report by using elements that the terminal device is notified of by the base station device 101 and by independently determining the other elements. In any case, the terminal device 102 transmits information relating to the configuration of the measurement report (e.g., information indicating the configuration or a request like that described above) to the base station device 101. This is because the base station device 101 needs to know elements that the terminal device 102 has determined independently.

By receiving information relating to the configuration of a measurement report from the terminal device 102 as described above, the base station device 101 can recognize in what form the measurement report will arrive. Then, the base station device 101 receives the measurement report, and obtains the content of the measurement report (the reception quality of reference signals, and, if necessary, IDs of beams corresponding to the reception quality). The base station device 101 may input at least some of the obtained reception quality of the reference signals to the trained model held in the base station device 101 to identify a beam to be used for communication with the terminal device 102 from among the first beams 111. Alternatively, the base station device 101 may provide information of the obtained reception quality of the reference signals (and, if necessary, IDs of beams corresponding to the reception quality) to another network node holding a trained model, for example. In this case, at least some of the reception quality of the reference signals is input to the trained model in the other network node, and a beam to be used by the base station device 101 for communication with the terminal device 102 is selected from among the first beams 111. Then, the base station device 101 is notified of information of the determined beam, and the base station device 101 may determine a beam to be used for communication with the terminal device 102 from among the first beams 111 in accordance with the notification. Then, the base station device 101 communicates with the terminal device 102 with use of the beam.

As described above, in the present embodiment, the terminal device 102 determines the configuration of a measurement report, notifies the base station device 101 of information relating to the configuration, and transmits the measurement report based on the configuration. Therefore, measurement results appropriate for selecting a beam with use of artificial intelligence (AI)/machine learning (ML) can be shared between the base station device 101 and the terminal device 102 without excess or deficiency according to, for example, the reception quality of reference signals transmitted using respective beams and received by the terminal device 102.

It should be noted that the base station device 101 may notify the terminal device 102 in advance of a condition for determining measurement results to be reported from among the measurement results of the second beams when the terminal device 102 determines the configuration of a report. For example, the base station device 101 may notify the terminal device 102 in advance of information indicating a predetermined value that measurement results to be reported should exceed, as the condition. In this case, the terminal device 102 includes, in the report, measurement results of reference signals (beams) whose reception quality is higher than the predetermined value, and does not include, in the report, measurement results of reference signals for which only reception quality not higher than the predetermined value can be obtained. For example, in a case where a learning model is generated in a learning phase of machine learning by replacing reception quality values not higher than the predetermined value with the predetermined value, even if reception quality values not higher than the predetermined value are reported, those values will not be used in the inference phase. Therefore, the base station device 101 notifies the terminal device 102 of the above condition so that such reception quality values will not be reported. It should be noted that, if the terminal device 102 selects report target beams in accordance with the above condition, the number of reported measurement results is variable. Therefore, the terminal device 102 transmits information relating to the configuration of a report to the base station device 101 as described above, and notifies the base station device 101 of measurement results in accordance with the configuration.

The above condition may also include information indicating the maximum number of reference signals (beams) to be reported. For example, if a trained model is generated by using only the reception quality of a predetermined number of reference signals in the learning phase of machine learning, the number of reception quality values to be input to the trained model may also be limited to the predetermined number. Accordingly, even if measurement results of the reception quality of beams more than the predetermined number are reported, the measurement results of beams other than the predetermined number of beams will not be used for the beam selection. Therefore, the base station device 101 may notify the terminal device 102 of, for example, a condition including the predetermined number as the maximum number of reference signals to be reported. If the number of beams whose reception quality satisfies the above condition is more than the predetermined number, for example, the terminal device 102 does not report measurement results of the reception quality of beams other than the predetermined number of beams to the base station device 101.

The base station device 101 may transmit the above condition periodically, for example. Upon obtaining the condition, the terminal device 102 compares the condition with conditions held at that point in time. If the terminal device 102 has received a condition different from the held conditions, the terminal device 102 updates the held conditions based on the received condition. Alternatively, the base station device 101 may transmit a condition each time the trained model is updated. Upon obtaining the condition, the terminal device 102 updates the held conditions based on the obtained condition. When reporting measurement results, the terminal device 102 determines the content and configuration of the report based on the latest conditions, notifies the base station device 101 of information relating to the configuration of the report, generates a measurement report using the configuration, and transmits the measurement report to the base station device 101.

By using conditions as described above, it is possible to prevent unnecessary feedback of information that will not be input to the trained model and will not be used for the determination of a beam to be used by the base station device 101.

### Device Configuration

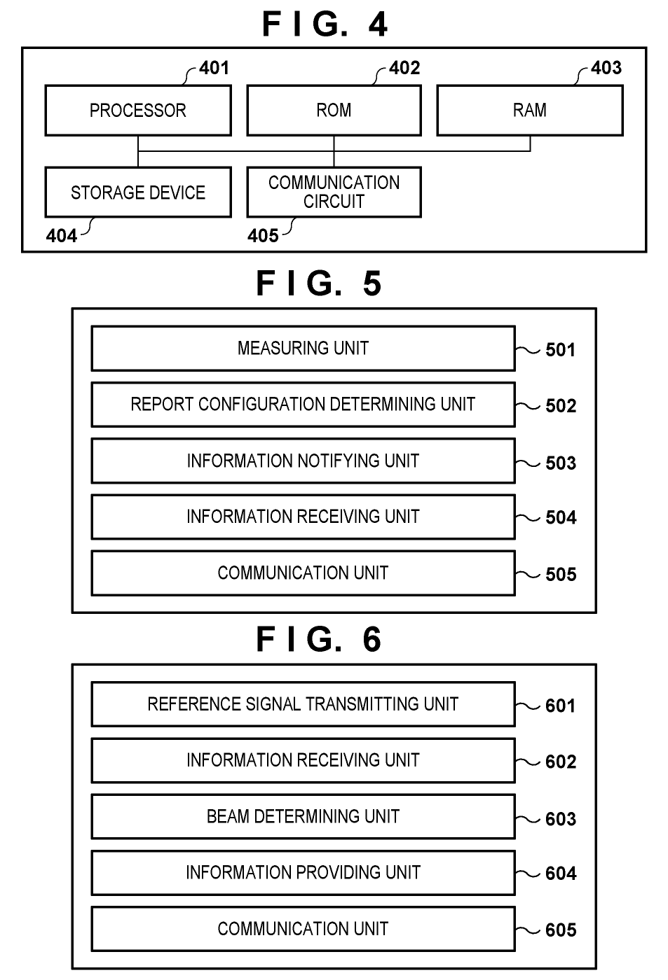

FIG. 4 shows an example of a hardware configuration of the base station device 101 and the terminal device 102 according to the present embodiment. For example, the base station device 101 and the terminal device 102 are configured to include a processor 401, a ROM 402, a RAM 403, a storage device 404, and a communication circuit 405. The processor 401 is a computer including one or more processing circuits such as a general-purpose CPU (Central Processing Unit) and an application-specific integrated circuit (ASIC), and reads and executes a program stored in the ROM 402 or the storage device 404 to execute processing of the entire device and each process described above. The ROM 402 is a read only memory for storing programs and information such as various parameters relating to processing executed by the base station device 101 or the terminal device 102. The RAM 403 is a random access memory that functions as a workspace when the processor 401 executes a program, and temporarily stores information. The storage device 404 is, for example, an attachable and detachable external storage device or the like. The communication circuit 405 is, for example, a circuit for wireless communication of the 5G or its successor standard. Although one communication circuit 405 is shown in FIG. 4, the base station device 101 and the terminal device 102 may include a plurality of communication circuits. For example, each of the base station device 101 and the terminal device 102 may include wireless communication circuits for the 5G and its successor standard, and an antenna common to those circuits. It should be noted that the base station device 101 and the terminal device 102 may include separate antennas suitable for the respective standards. The base station device 101 may further include a wired communication circuit used for communication with other base station devices or nodes in a core network. The terminal device 102 may further include a communication circuit conforming to a wireless communication standard other than cellular communication standards such as a wireless local area network (LAN) and Bluetooth (registered trademark). Note that the base station device 101 and the terminal device 102 may include separate communication circuits 405 for a plurality of available frequency bands or a common communication circuit 405 for at least part of those frequency bands.

FIG. 5 shows an example of a functional configuration of the terminal device 102. The terminal device 102 includes, for example, a measuring unit 501, a report configuration determining unit 502, an information notifying unit 503, an information receiving unit 504, and a communication unit 505. It should be noted that FIG. 5 shows only functions particularly relating to this embodiment, and illustration of various other functions that the terminal device 102 may have is omitted. For example, the terminal device 102 naturally has other functions that terminal devices conforming to the 5G, its successor standard, or the like commonly have. Also, the functional blocks are schematically shown in FIG. 5, and the functional blocks may be implemented integrally or may be further subdivided. In addition, the functions shown in FIG. 5 may be implemented, for example, by the processor 401 by executing a program stored in the ROM 402 or the storage device 404, or may be implemented, for example, by a processor included in the communication circuit 405 by executing predetermined software. The above-described details of processing executed by the functional units will not be described here, and the functions of the functional units will be outlined.

The measuring unit 501 measures the reception quality of reference signals transmitted using a plurality of second beams, respectively, which are fewer than the large number of first beams that can be formed by the base station device 101. The measuring unit 501 may measure the reception quality of reference signals transmitted by the first beams, respectively, in the learning phase of machine learning for the beam determination in the base station device 101, for example. The report configuration determining unit 502 determines the configuration of a report when the measurement results of reference signals are reported to the base station device 101. For example, the report configuration determining unit 502 may determine at least one of the number of reference signals to be reported, the number of signals to be used to transmit the report, a form for expressing the measurement results of the reception quality (whether or not to use difference values), and a bit width to be used to express the measurement results of the reception quality. It should be noted that the report configuration determining unit 502 may obtain information designating part of the configuration or information of a condition from the base station device 101 via the information receiving unit 504, for example, and determine configuration elements other than that designated by the base station device 101. The report configuration determining unit 502 requests the base station device 101 to use the determined configuration, and based on a response to the request, determines the configuration of a measurement report to be finally used. The information notifying unit 503 notifies the base station device 101 of information relating to the configuration determined by the report configuration determining unit 502. Also, the information notifying unit 503 generates a measurement report using the configuration, and transmits the measurement report to the base station device 101. The information receiving unit 504 receives, from the base station device 101, information designating part of the configuration of the measurement report and a condition for selecting measurement results to be reported. The communication unit 505 communicates with the base station device 101 by using a beam that is selected from among the first beams that can be formed by the base station device 101 based on information of the measurement results that the base station device is notified of by the information notifying unit 503.

FIG. 6 shows an example of a functional configuration of the base station device 101. The base station device 101 includes, for example, a reference signal transmitting unit 601, an information receiving unit 602, a beam determining unit 603, an information providing unit 604, and a communication unit 605. It should be noted that FIG. 6 shows only functions particularly relating to this embodiment, and illustration of various other functions that the base station device 101 may have is omitted. For example, the base station device 101 naturally has other functions that base station devices conforming to the 5G, its successor standard, or the like commonly have. Also, the functional blocks are schematically shown in FIG. 6, and the functional blocks may be implemented integrally or may be further subdivided. In addition, the functions shown in FIG. 6 may be implemented, for example, by the processor 401 by executing a program stored in the ROM 402 or the storage device 404, or may be implemented, for example, by a processor included in the communication circuit 405 by executing predetermined software. The above-described details of processing executed by the functional units will not be described here, and the functions of the functional units will be outlined.

The reference signal transmitting unit 601 transmits reference signals (CSI-RS, SSB, etc.) using the first beams and the second beams, respectively. If the second beams are some of the first beams, there is no need to transmit reference signals for the second beams separately. The information receiving unit 602 receives information relating to the configuration of a measurement report from the terminal device 102. Also, the information receiving unit 602 receives a measurement report from the terminal device 102, analyzes the measurement report by using the configuration based on the received information, and obtains information of measurement results.

The beam determining unit 603 determines a beam to be used for communication with the terminal device 102 from among the first beams based on a result of inputting the information of the measurement results obtained from the terminal device 102 to the trained model. In one example, a small number of (two or more) candidate beams may be specified from among the large number of first beams, as an output from the trained model. In this case, the beam determining unit 603 may notify the terminal device 102 of information of the candidate beams and cause the terminal device to measure reference signals transmitted from the reference signal transmitting unit 601 with use of the candidate beams, respectively. Then, the beam determining unit 603 may obtain measurement results of the candidate beams from the terminal device 102, and determine a beam to be finally used for communication with the terminal device 102. In another example, the beam to be finally used for communication with the terminal device 102 may be directly specified from among the large number of first beams, based on an output from the trained model. Alternatively, the trained model may be held by another network node outside the base station device 101, and in this case, the beam determining unit 603 provides the other network node with the information of the measurement results obtained from the terminal device 102. Then, the beam determining unit 603 may obtain a result of inference performed using the trained model from the other network node, and determine the beam to be used for communication with the terminal device 102 based on the obtained result. In one example, the trained model may output, as the result of inference, communication quality expected to be obtained with respect to each of the first beams. In this case, the beam determining unit 603 may determine a beam having the highest communication quality or a beam selected at random or by following a predetermined rule from among beams having communication quality higher than a predetermined value, as the beam to be used for communication with the terminal device 102. Also, the beam determining unit 603 may select, as the candidate beams described above, a predetermined number of beams in descending order of the communication quality or a predetermined number of beams selected at random or by following a predetermined rule from among beams having communication quality higher than a predetermined value.

The information providing unit 604 provides the terminal device 102 with, for example, information designating part of the configuration of a measurement report, information of a condition to be used by the terminal device 102 to select report target beams, and the like. If information relating to the configuration of a measurement report, which has been received by the information receiving unit 602, is information indicating a request to use the configuration, the information providing unit 604 determines, for example, whether to accept, modify, or reject the configuration, and transmits a response according to the content of the determination to the terminal device 102. The communication unit 605 communicates with the terminal device 102 by using the beam determined by the beam determining unit 603.

### Flow of Processing

Next, an example of the flow of processing executed in the wireless communication system will be described. Here, an example in which CSI-RS is measured as a reference signal is shown, but the terminal device 102 may measure another reference signal and notify the base station device 101 of the measurement result. The flow of the processing described below is merely an example, and the modifications described above can be made on each procedure. Since the details of each procedure are as described above, the outline of the flow of processing will be described here and description of the details will not be repeated.

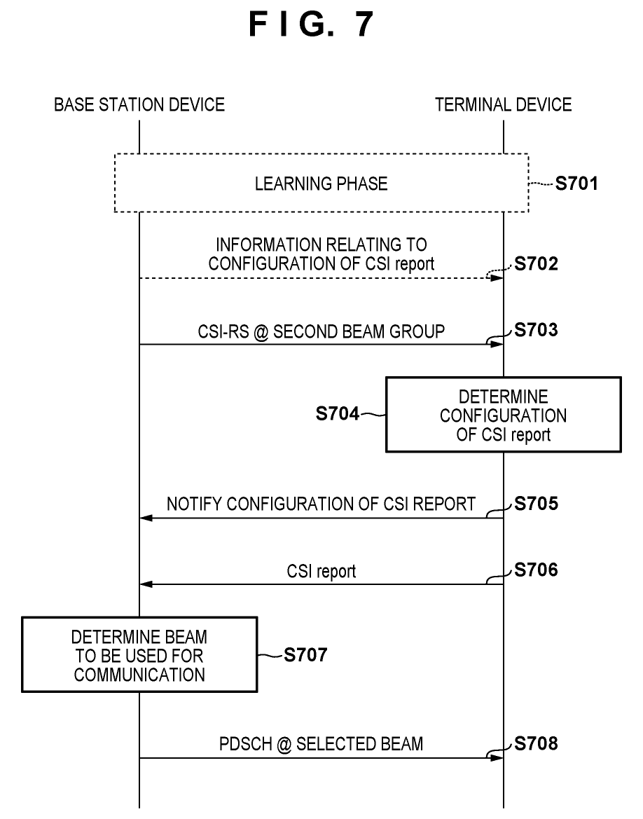

FIG. 7 shows a first processing example of the terminal device 102. In the present embodiment, a beam to be used for communication with the terminal device 102 is selected through machine learning from a large number of first beams that can be formed by the base station device 101 based on, for example, measurement results of reference signals transmitted using second beams (e.g., some of the first beams or prepared separately from the first beams) fewer than the first beams. Therefore, the base station device 101 first executes processing of the learning phase with the terminal device 102 (S701) and generates a trained model. It should be noted that the base station device 101 may execute the processing of the learning phase with another terminal device different from the terminal device 102 and may not execute the processing of the learning phase with the terminal device 102. In the learning phase, for example, the base station device 101 transmits reference signals using the first beams and the second beams, respectively, and the terminal device 102 measures the reception quality of the reference signals. Then, the terminal device 102 feeds back all the measurement results of the reception quality to the base station device 101, and machine learning is executed by the base station device 101 or another network node using the feedback relating to the second beams as an input and using the feedback relating to the first beams as teaching data. When the learning phase is complete, a trained model is generated.

After the learning phase is complete, the terminal device 102 measures the reception quality of reference signals transmitted from the base station device 101 with use of the second beams, respectively (S703), and determines the configuration of a report (CSI Report) for reporting the measurement results of the reception quality (S704). The base station device 101 may provide the terminal device 102 with information designating part of the configuration of the report (S702). It should be noted that the terminal device 102 may determine the entire configuration, in which case, the processing of step S702 is omitted.

The terminal device 102 transmits information relating to the configuration of the report determined in step S704 to the base station device 101 (S705). Also, the terminal device 102 transmits the report of the measurement results to the base station device 101 based on the configuration that the base station device 101 is notified of in step S705 (S706). Although FIG. 7 shows an example in which the information relating to the configuration and the report of the measurement results are transmitted separately, there is no limitation to this configuration. That is to say, the information and the report may be transmitted to the base station device 101 by one signal. In other words, the terminal device 102 may include, in the report (CSI Report) including information indicating the measurement results, information indicating the configuration of the report. Also, the notification given in step S705 may include information requesting the base station device 101 to use the configuration. In this case, the base station device 101 may transmit a response (not shown) including information indicating approval, modification, or rejection of the request to the terminal device 102. In this case, upon receiving a response indicating approval, the terminal device 102 transmits a report including information indicating the measurement results to the base station device 101 by using the configuration that the base station device 101 has been notified of in step S705, and upon receiving a response indicating modification, the terminal device 102 transmits the report by using another configuration obtained by modifying the configuration that the base station device 101 has been notified of in step S705 in accordance with the content of the modification. Also, upon receiving a response indicating rejection, the terminal device 102 may execute the processing of step S704 again and transmit a signal requesting to use the determined configuration again to the base station device 101. It should be noted that, in the case where the request is transmitted to the base station device 101, separate signals are used to transmit the notification in step S705 and the report in step S706.

Upon receiving the report of the measurement results of the reception quality of the reference signals in step S706, the base station device 101 determines to use a beam selected from among the first beams as a result of the information of the measurement results being input to the trained model (step S707). In the case where the trained model is held by a network node different from the base station device 101, the information of the measurement results is transferred from the base station device 101 to the network node, and the beam to be used is determined by the network node. Then, the base station device 101 is notified of the determined beam, and the base station device 101 determines to use the beam. Then, the base station device 101 can transmit, for example, a signal of a downlink (e.g., a physical downlink shared channel (PDSCH)) to the terminal device 102.

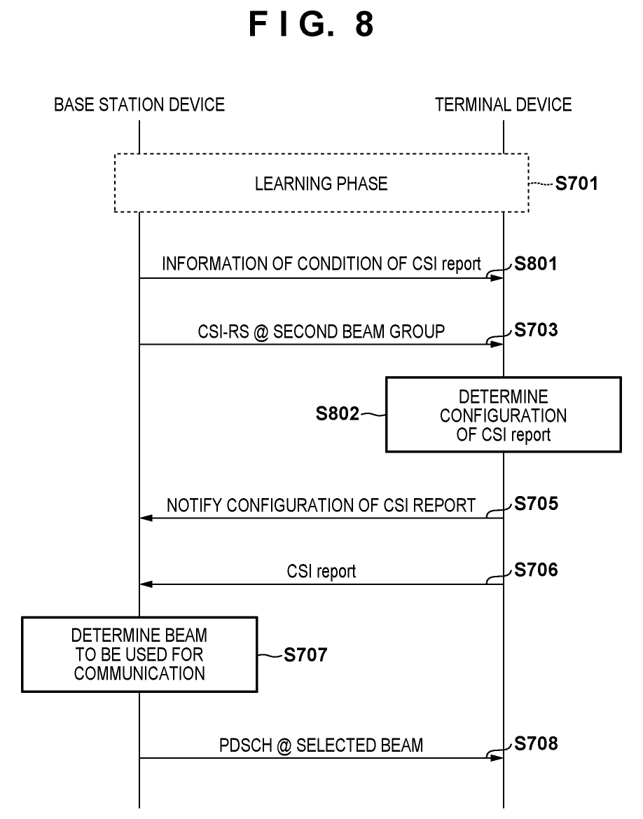

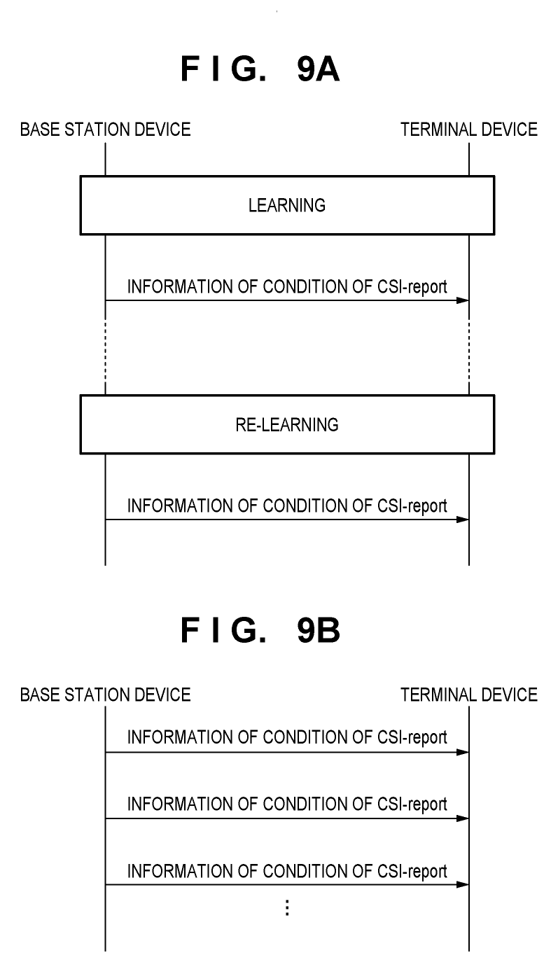

FIG. 8 shows an example of the flow of processing of a case where the base station device 101 notifies the terminal device 102 of a condition to be used to select beams whose measurement results are to be reported, instead of designating some elements of the configuration in step S702 shown in FIG. 7. Before the measurement report is made, the base station device 101 notifies the terminal device 102 of, for example, information indicating a predetermined value that the reception quality of a reference signal should exceed as a condition to be used to select beams whose measurement results are to be reported (S801). Also, the terminal device may be notified of information indicating the maximum number of report target beams, as the condition. The terminal device 102 measures the reception quality of reference signals transmitted using the second beams, and determines the configuration of the report such that the base station device 101 will be notified of only measurement results satisfying the condition, for example (S802). The following processing is the same as that shown in FIG. 7. It should be noted that the information of the condition may be given each time the trained model is updated by machine learning as shown in FIG. 9A, or may be given periodically as shown in FIG. 9B. Alternatively, the base station device 101 may notify the terminal device 102 of the information of the condition when the terminal device 102 is connected to the base station device 101, for example.

As described above, in this embodiment, it is possible to flexibly configure feedback transmitted from the terminal device 102 to the base station device 101. Therefore, feedback for selecting a beam to be used by the base station device 101 using artificial intelligence (AI)/machine learning (ML) can be prevented from becoming excessive or insufficient. Therefore, it is possible to contribute to Goal 9 “build resilient infrastructure, promote sustainable industrialization, and foster innovation” of the sustainable development goals (SDGs) lead by the United Nations.

According to the present invention, it is possible to appropriately configure feedback from a terminal device to a base station device for a method for selecting a beam to be used by the base station device with use of an AI/ML model.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A terminal device comprising:
a measurement unit configured to measure reference signals transmitted using second beams, respectively, from a base station device, the base station device being capable of forming a plurality of first beams, and a beam to be used for communication with the terminal device being determined for the base state device from among the plurality of first beams by at least some of measurement results obtained by measurement of the reference signals by the terminal device being input to a trained model obtained through machine learning, a total number of the second beams being fewer than the first beams;
a determination unit configured to determine a configuration of a report of the measurement results of the reference signals; and
a transmission unit configured to transmit a notification relating to the configuration of the report to the base station device and transmitting a measurement report of the reference signals to the base station device based on the configuration of the report.

2. The terminal device according to claim 1, further comprising:
a reception unit configured to receive information regarding a second configuration of the report of the measurement results of the reference signals from the base station device,
wherein the transmission unit transmits a measurement report of the reference signals having the configuration of the report and the second configuration of the report.

3. The terminal device according to claim 2,
wherein the second configuration of the report includes a configuration relating to a total number of beams for which corresponding measurement results are reported, out of the plurality of second beams, and
the configuration of the report determined by the determination unit includes a configuration relating to at least one of a total number of signals to be used to report the measurement results, content of the report regarding each beam, and a bit width of information indicating the measurement results of the reference signals.

4. The terminal device according to claim 1,
wherein the configuration of the report includes a configuration relating to at least one of a total number of beams for which corresponding measurement results are reported, out of the plurality of second beams, content of the report regarding each beam, and a bit width of information indicating the measurement results of the reference signals.

5. The terminal device according to claim 1,
wherein the transmission unit transmits the notification relating to the configuration of the report and the measurement report of the reference signals by using separate signals.

6. The terminal device according to claim 5,
wherein the transmission unit requests, in the notification, the base station device to use the configuration of the report, and transmits the measurement report of the reference signals to the base station device by using a configuration determined by the base station device based on the request.

7. The terminal device according to claim 1,
wherein the transmission unit transmits the measurement report of the reference signals and the notification relating to the configuration of the report by using one signal.

8. A base station device comprising:
a transmission unit configured to transmit reference signals by using second beams, respectively, a total number of the second beams being fewer than a plurality of first beams formable by the base station device;
a reception unit configured to receive, from a terminal device that received the reference signals, a notification relating to a configuration of a report of measurement results of the reference signals, and receiving a measurement report of the reference signals based on the configuration of the report; and
a determination unit configured to determine a beam to be used for communication with the terminal device from among the plurality of first beams by inputting at least some of the measurement results of the reference signals included in the measurement report to a trained model obtained through machine learning.

9. The base station device according to claim 8, further comprising:
a notification unit configured to notify the terminal device of information regarding a second configuration of the report of the measurement results of the reference signals,
wherein the reception unit receives, from the terminal device, a measurement report of the reference signals having the configuration of the report and the second configuration of the report.

10. The base station device according to claim 9,
wherein the second configuration of the report includes a configuration relating to a total number of beams for which corresponding measurement results are reported, out of the plurality of second beams, and
the configuration of the report included in the notification includes a configuration relating to at least one of a total number of signals to be used to report the measurement results, content of the report regarding each beam, and a bit width of information indicating the measurement results of the reference signals.

11. The base station device according to claim 8,
wherein the configuration of the report includes a configuration relating to at least one of a total number of beams for which corresponding measurement results are reported, out of the plurality of second beams, content of the report regarding each beam, and a bit width of information indicating the measurement results of the reference signals.

12. The base station device according to claim 8,
wherein the reception unit receives the notification relating to the configuration of the report and the measurement report of the reference signals transmitted using separate signals.

13. The base station device according to claim 12,
wherein the reception unit receives the notification including a request to use the configuration of the report, and
the base station device further comprising:
a specifying unit configured to specify a configuration to be used for a report of the measurement results of the reference signals, based on the request; and
an instruction unit configured to instruct the terminal device to use the specified configuration, and
the reception unit receives a measurement report of the reference signals transmitted by the terminal device using the specified configuration.

14. The base station device according to claim 8,
wherein the reception unit receives one signal including both the measurement report of the reference signals and the notification relating to the configuration of the report.

15. A control method executed by a terminal device, the method comprising:
measuring reference signals transmitted using second beams, respectively, from a base station device, the base station device being capable of forming a plurality of first beams, and a beam to be used for communication with the terminal device being determined for the base station device from among the plurality of first beams by at least some of measurement results obtained by measurement of the reference signals by the terminal device being input to a trained model obtained through machine learning, a total number of the second beams being fewer than the first beams;
determining a configuration of a report of the measurement results of the reference signals; and
transmitting a notification relating to the configuration of the report to the base station device and transmitting a measurement report of the reference signals to the base station device based on the configuration of the report.

16. A control method executed by a base station device, the control method comprising:
transmitting reference signals by using second beams, respectively, a total number of the second beams being fewer than a plurality of first beams formable by the base station device;
receiving, from a terminal device that received the reference signals, a notification relating to a configuration of a report of measurement results of the reference signals, and receiving a measurement report of the reference signals based on the configuration of the report; and
determining a beam to be used for communication with the terminal device from among the plurality of first beams by inputting at least some of the measurement results of the reference signals included in the measurement report to a trained model obtained through machine learning.

17. A non-transitory computer readable storage medium that stores a program for causing a computer included in a terminal device to:
measure reference signals transmitted using second beams, respectively, from a base station device, the base station device being capable of forming a plurality of first beams, and a beam to be used for communication with the terminal device being determined for the base station device from among the plurality of first beams by at least some of measurement results obtained by measurement of the reference signals by the terminal device being input to a trained model obtained through machine learning, a total number of the second beams being fewer than the first beams;
determine a configuration of a report of the measurement results of the reference signals; and
transmit a notification relating to the configuration of the report to the base station device and transmit a measurement report of the reference signals to the base station device based on the configuration of the report.

18. A non-transitory computer readable storage medium that stores a program for causing a computer included in a base station device to:
transmit reference signals by using second beams, respectively, a total number of the second beams being fewer than a plurality of first beams formable by the base station device;
receive, from a terminal device that received the reference signals, a notification relating to a configuration of a report of measurement results of the reference signals, and receiving a measurement report of the reference signals based on the configuration of the report; and
determine a beam to be used for communication with the terminal device from among the plurality of first beams by inputting at least some of the measurement results of the reference signals included in the measurement report to a trained model obtained through machine learning.
